(19) United States
(12) Patent Application Publication
(10) Pub. No.: US 2012/0240896 A1
(43) Pub. Date: Sep. 27, 2012

(54) Internal Combustion Engine with Rotating Cylinder Block

(76) Inventor: Tadeusz Slawinski, Linden, NJ (US)

(21) Appl. No.: 13/053,015

(22) Filed: Mar. 21, 2011

(51) Int. Cl. F02B 59/00

(52) U.S. Cl. 123/200

(57) ABSTRACT

The invention presents an internal combustion engine with rotating cylinder block able to use liquid and gas fuel. The design allows substantial reduction of weight and vibration in comparison with engines presently in use and will be preferred for use in weight sensitive vehicles. Ability to make part of the cylinders inactive improves fuel efficiency at partial loads.

While the engine operation is similar to typical internal combustion engine, the configuration of cylinders and inlet-outlet valves is different. The engine consists of a cylinder block with radially positioned cylinders open to the outside, pistons moving inside cylinders and valve units (or piston units) positioned outside the perimeter the cylinder block and synchronized to open and close inlet-outlet openings located in pistons.

### BACKGROUND OF THE INVENTION

Internal combustion engines are the principal source of power in moving vehicles d industrial application. The most popular are reciprocating piston engines. In those type of engines cylinders are positioned in-line and pistons move, stop and reverse direction two or four times per each revolution of the engine. The power of the combustion is transferred from pistons to piston rods and crankshaft. Reciprocating movements of the pistons and piston rods create forces that cause engine vibration. Such engines require complex valve systems to supply fuel and air to the combustion chamber and crankshaft to transfer the power to the power output flange. Crankshaft is the most expensive part of such reciprocating engine. While rotary type engines such as the Wankel engine (U.S. Pat. No. 2,988,065) do not have many disadvantages of the reciprocating engine and do not need crankshafts, they have found only limited use due to such disadvantages as poor fuel efficiency, limited life of some parts and high pollution in the exhaust gases.

### DESCRIPTION OF THE INVENTION

The invention presents an internal combustion engine with rotating cylinder block and rotating valve units. The engine does not have crankshaft and the power is transferred though the rotating valve units to the output using rotating shafts and reduction gears that they do not reciprocate. The engine does not have crankshaft and has substantially reduced weight and vibration in comparison with typical reciprocating engines of the similar power. While the engine can be built with variable number of cylinders, large number of cylinders result in increased weight and is clearly impractical.

The description of design and operation of the is shown for an eight cylinder engine. Other numbers of cylinders are possible, as well as multiple cylinder blocks attached to the same axle.

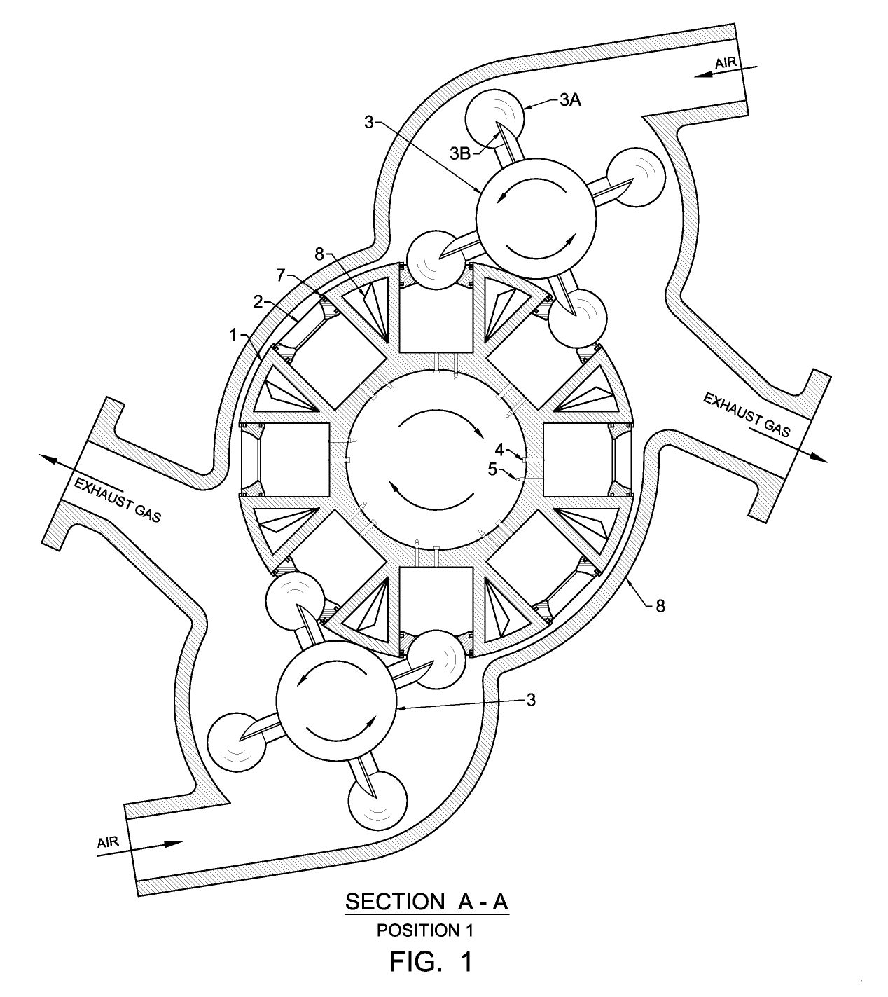

FIG. 1 shows engine cross section through the center lines of cylinders.

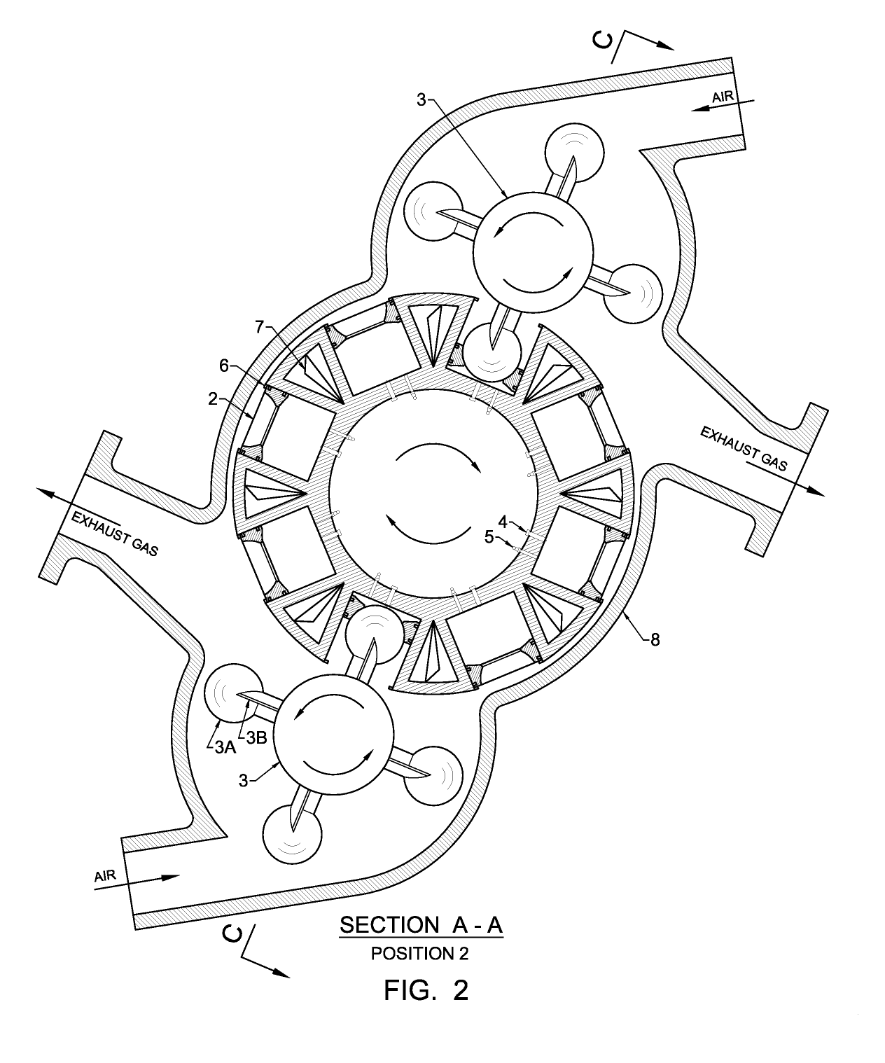

FIG. 2 shows engine cross section through the center lines of cylinders in different position of main parts than shown on FIG. 1.

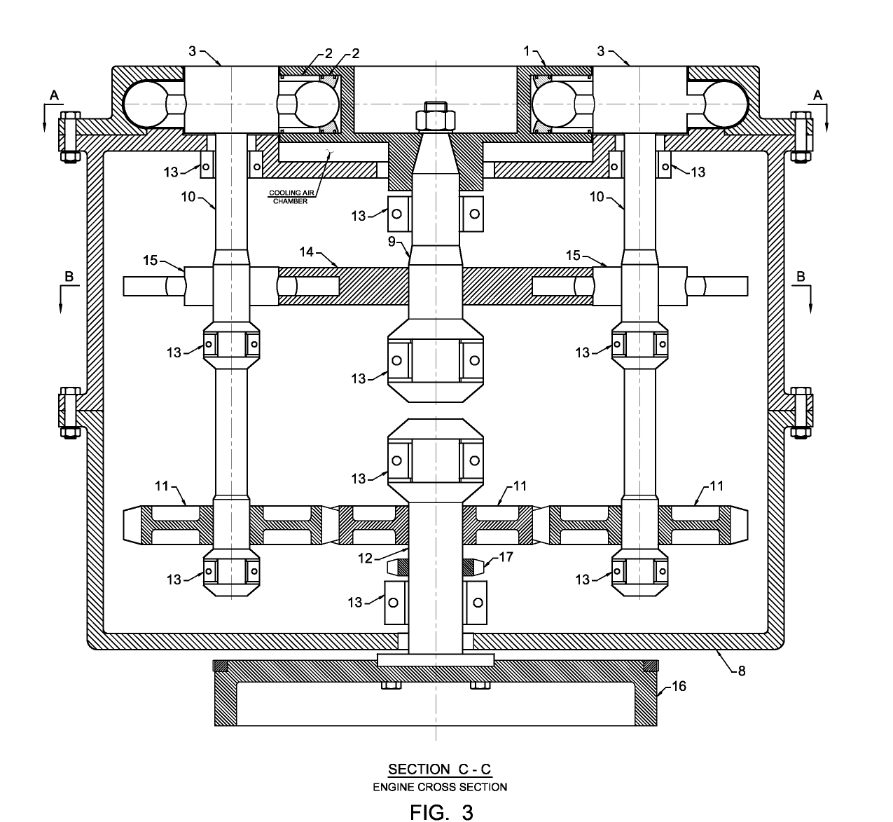

FIG. 3 shows engine cross section through the center lines of shafts.

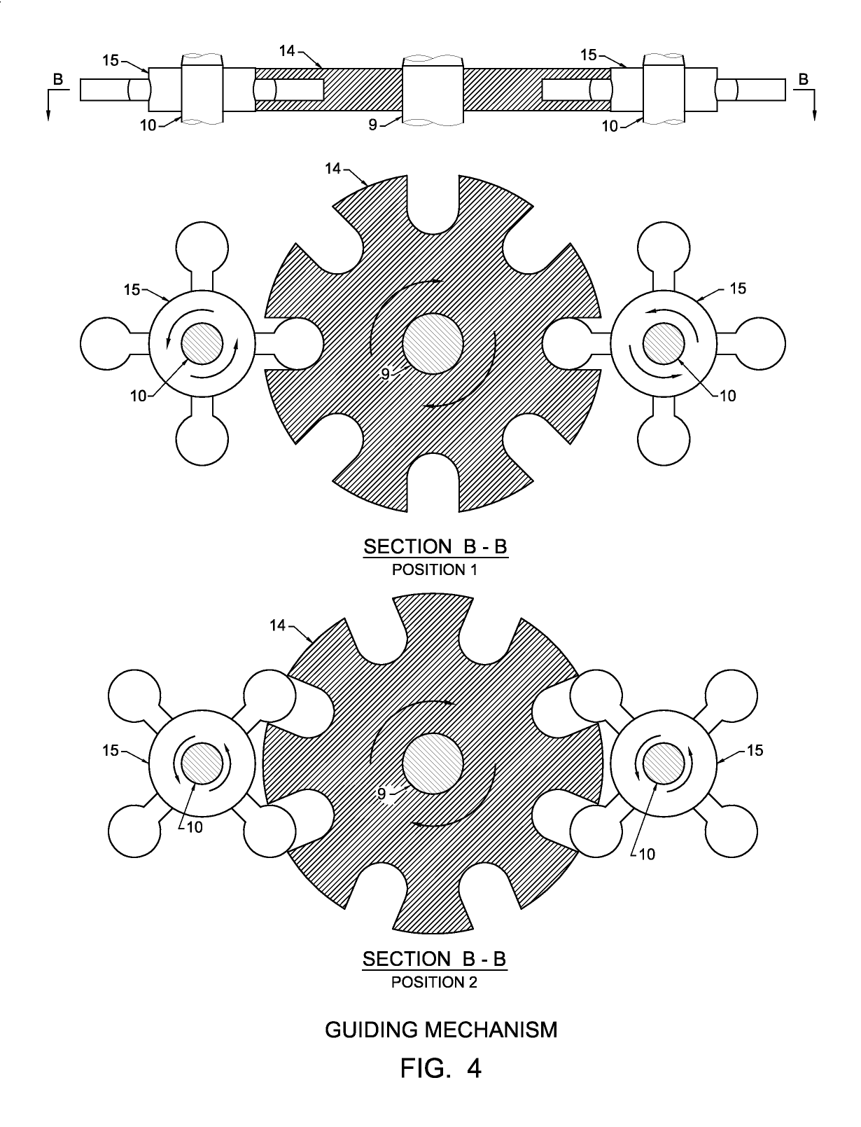

FIG. 4 shows guiding mechanism of the engine that synchronizes rotation of valve units with rotation of the cylinder block.

The engine design can be explained using FIG. 1, FIG. 2, FIG. 3 and FIG. 4. The cylinder block, Item (1), has cylinders positioned radially. Each cylinder has a piston, Item (2), inside. Each piston is of cylindrical shape, has inlet/outlet partial spherical shape opening at the center and sealing rings. Two valve units, Item (3), positioned on the opposite sides of the cylinder block, have four balls, Item (3A), each working as valves. Each cylinder has a fuel injector, Item (4), spark plug, Item (5) and a piston restraining-holding magnetic ring at the entrance, Item (6). (4), spark plug, Item (5) and magnetic piston restraining-holding ring, Item (6) at the entrance to the cylinder. The purpose of the ring is to prevent piston from moving out of the cylinder and magnetically hold piston at the entrance to the cylinder during low speed of the engine when centrifugal is not strong enough to keep pistons at that position. Blades, Item (7), are positioned inside the spaces between the cylinders to increase flow of air to cool the cylinder block. Cylinder block (1) and valve units (3) rotate inside engine housing, Item (8), which has an air inlet and exhaust gas outlet each. The direction of rotations are shown with arrows. FIG. 3 shows engine cross section. Cylinder block (1) is attached to cylinder block shaft, Item (9), and each valve unit (3) is attached to power intake shaft, Item (10). Transmission gears, Item (11), transfer power to flywheel shaft, Item (12). Shaft bearings, Items (13), hold the shafts in place and transfer forces to housing (8). Guiding mechanism, shown also on FIG. 4, consisting of guiding disk, Item (14) and guiding stars, Item (15), is attached to cylinder block shaft (9) and power intake shaft (10) respectively. Flywheel, Item (16) is attached to the flywheel shaft, which transfers engine power to the outside. Oil pump driving gear, Item (17), drives lubricating pump (not shown). FIG. 4 shows the valve guiding mechanism that synchronizes rotation of the cylinder block with rotation of valve units. The cylindrical ends of the guiding star move inside the slots in guiding disk providing synchronization between cylinder block shaft and the power intake shaft. Another possibility to synchronize the rotation of the cylinder block is by replacing the guiding mechanism with gears attached to the cylinder block shaft and two engaged with it gears attached to the power intake shafts.

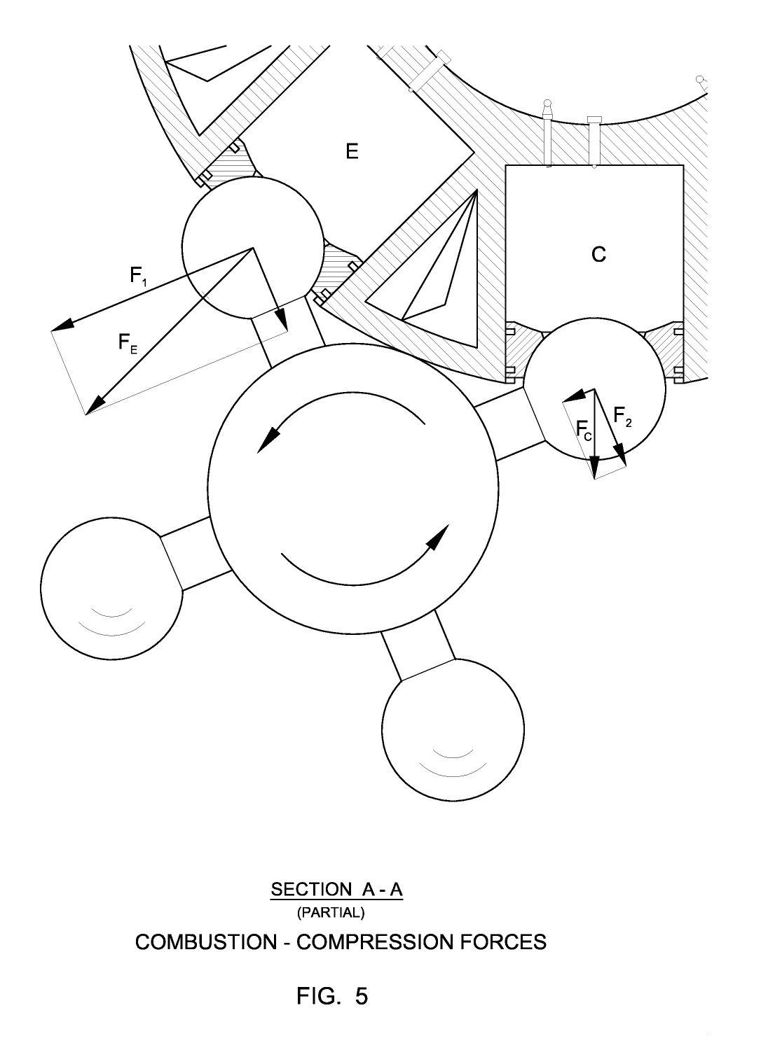

FIG. 5 is an enlarged partial section of FIG. 1 showing forces of compression and expansion of gases and illustrating principle of engine operation. Cylinder (E) is shown at the end of the expansion of the combustion gases and cylinder (C) is shown at the beginning of the compression cycle. The further rotation of the valve unit will compress the air inside cylinder (C) and open the valve that closes the opening in the piston located inside cylinder (E). At the selected moment at the end of the compression, the fuel injector injects fuel to the combustion chamber and spark plug provides spark required for the ignition of the fuel-air mixture. Pressure of the combustion gases pushes the piston away from the center of the cylinder block until the piston touches the piston restraining ring at the end of the cylinder. Further rotation of the valve unit opens the combustion chamber allowing escape of the exhaust gas to the exhaust opening in the housing. It is important to notice that the cylinder block rotates in opposite direction to the rotation of the valve units with the rotational speed equal to one half of the rotational speed of the valve units. This rotation cause the piston to stay at the end perimeter of the cylinder due to the centrifugal force of piston inside the cylinder and rotating with the cylinder block unless the piston is pressed by ball valve.

FIG. 5 shows vector F_{E}, force of the combustion gases transferred to the valve from engine piston and F_{C}, force needed to compress air inside the cylinder i.e. the force transferred from the ball valve to the piston. The difference between these two forces is the force rotating the valve unit. The torsional moment created by these force is transferred through the power intake shafts to the flywheel shaft. Part of this energy is lost for driving the guiding mechanism and in the reduction gears.

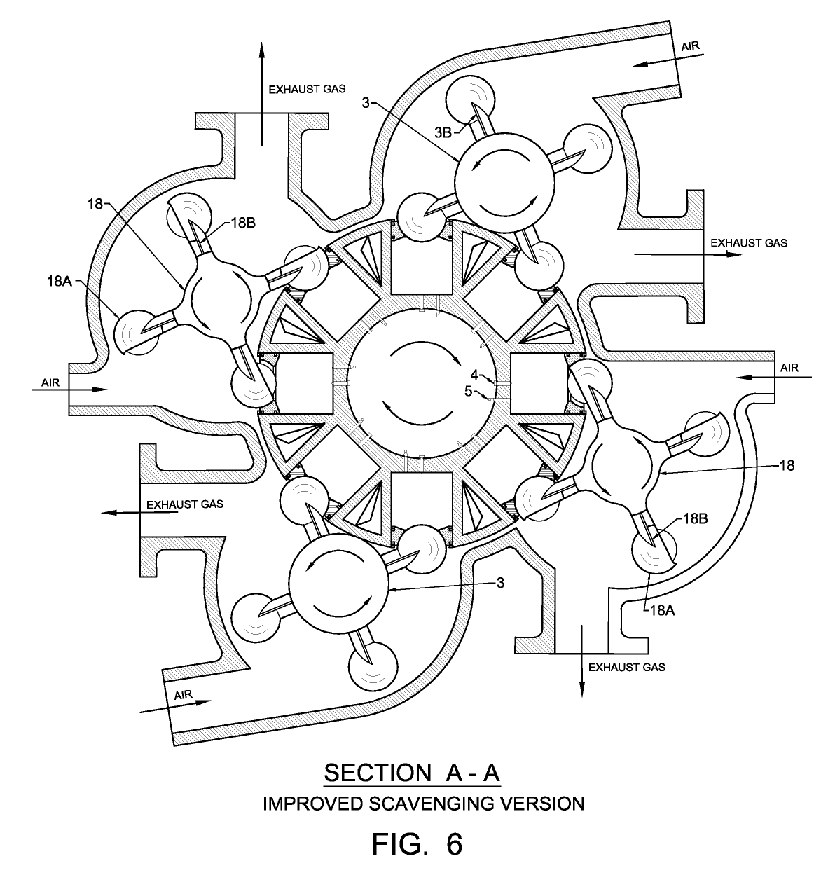

FIG. 6 shows a cross section of the engine through cylinder center lines of a modified version of the engine with improved scavenging of the exhaust gas from cylinders The modification consists of adding two scavenging units, Item (18). The scavenging units are similar to the valve units except that the ball at the end of the unit, Item (18A), is only partially spherical. Instead to close the opening in the piston (work as valve) it is machined in the middle to allow combustion gases to escape from the inside of cylinder, while having sufficient contact to the piston to push it to the bottom of each cylinder to squeeze out the gases. Thus, the scavenging units push the pistons inside the cylinders, but does not close the opening in the pistons. The scavenging unit has blades, Item (18B), similar to blades at the valve units, to force movement of gases.

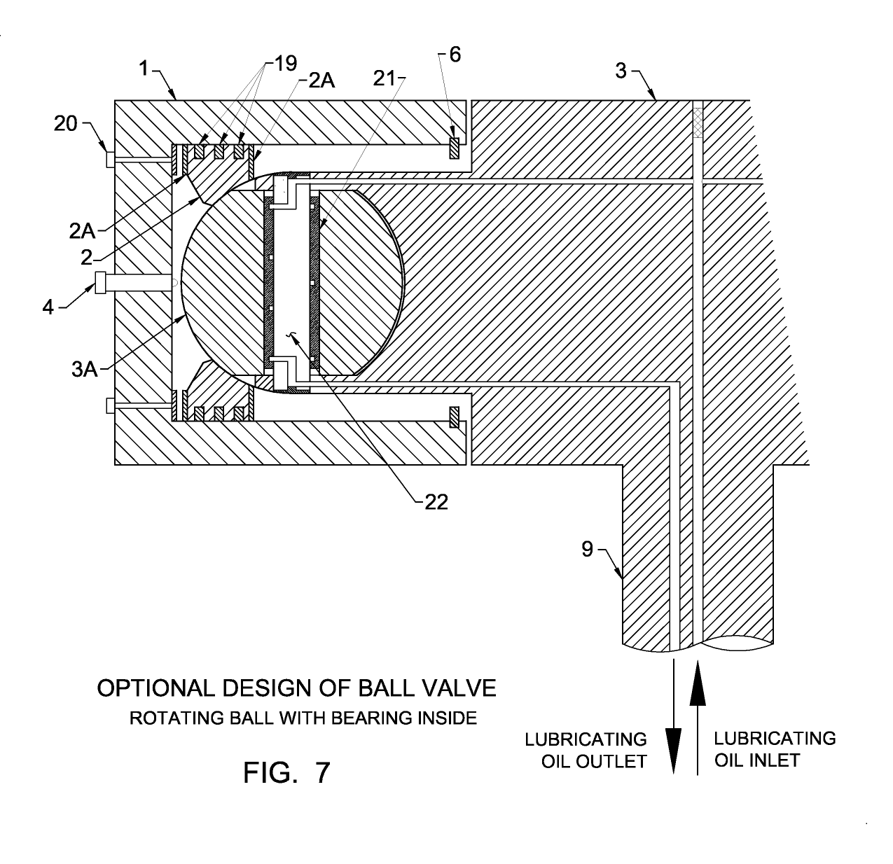

FIG. 7 shows a partial radial cross section parallel to the center lines of engine shafts of an optional design of the ball vales at the end of arms of the valve unit. Each piston has sealing rings, Item (19), and magnetic rings, Item (2A), on both sides. Each cylinder has electro-magnetic ring with solenoid, Item (20), which, when activated, holds piston at the bottom of the cylinder making the cylinder inactive. The purpose is increase of fuel efficiency of the engine at partial loads. The purpose The valve ball (3A) has an opening for bearing shell, Item (21), and is attached to the valve unit arm with a pin, Item (22), to reduce friction during valve operation. Valve unit housing has ducts and bearing shell has groves for supply and return of lubricating oil. The design with ball valves having bearings inside, has substantially reduced friction of transfer of force between piston and valve unit.

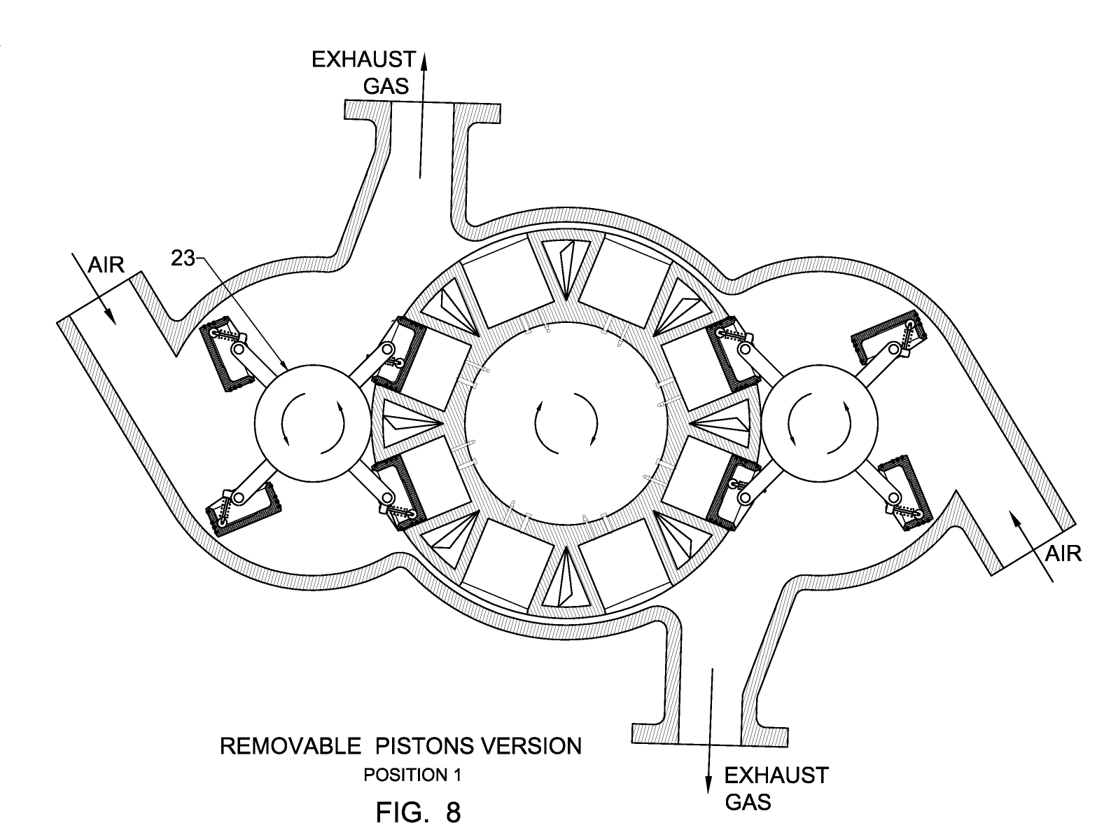

FIG. 8 shows a cross section cross section through the center lines of cylinders of another version of the engine design with valve units replaced by piston units, Item (23).

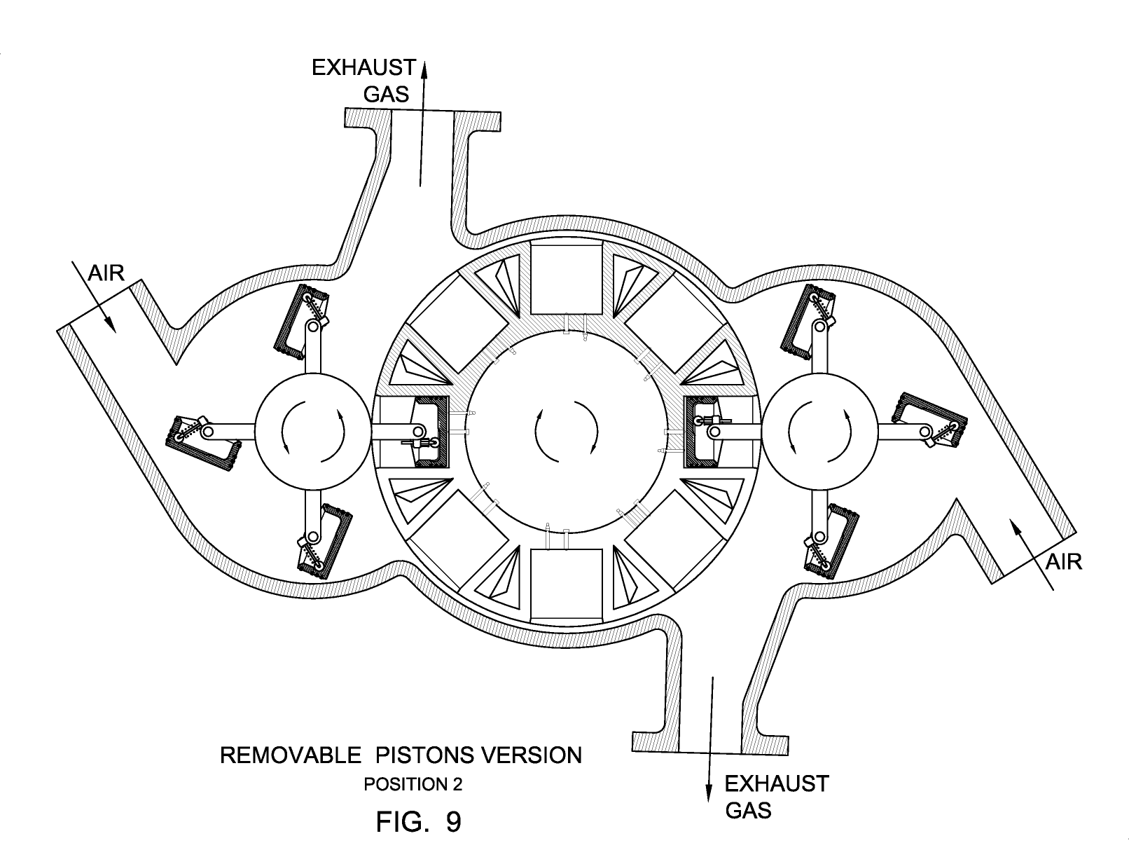

FIG. 9 shows a cross section cross section through the center lines of cylinders of the version of the engine shown on FIG. 8 design with different position of the valve units In relation to the cylinder block.

In he modified version shown on FIG. 8 and FIG. 9 the valve unit has been replaced by piston units, Item (23). Each piston units are similar to valve units, except that instead of balls at the end of each arm, they have specially designed pistons, i.e. instead of opening inlet-outlet valves in pistons, the pistons are removed from cylinders during each combustion cycle allowing escape of combustion gases and inlet of air. While the design is more complicated, scavenging of cylinders is substantially improved providing higher power and better fuel efficiency.

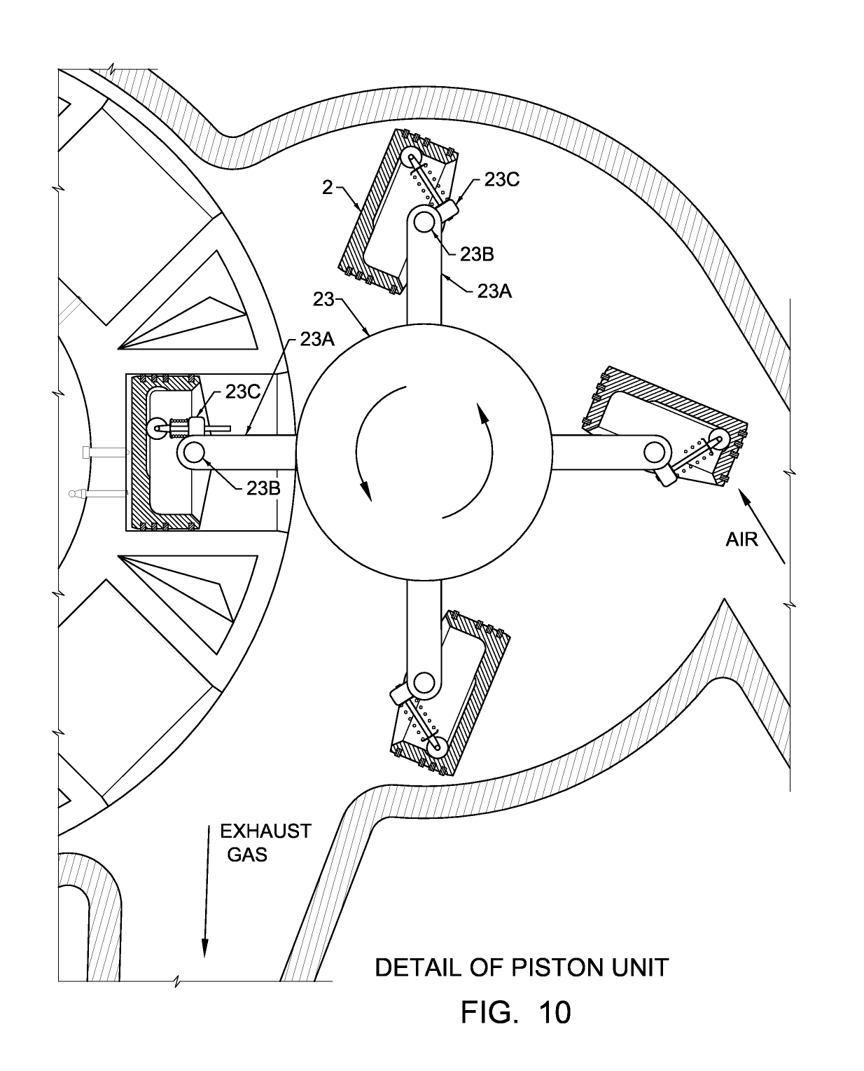

FIG. 10 shows and enlarged part of FIG. 9. The cylinders as well as pistons are modified to allow easy insertion of piston and provide positioning of pistons at the arms of the valve units which assures easy alignment of the piston with the entrance to the cylinder. Cylinders are slightly conical at the entrance. Pistons are attached to the ends to piston units arms, Item (23A), with a pin, Item 23B, and have a groove. They are positions and guided with piston guiding device, Item (23C), consisting of roller attached to a pin and a spring that pushes the roller to the piston. Each piston guiding device has limited ability to rotate around the pin to allow the roller to travel inside the groove in the cylinder. Pistons rotating at the ends of the piston unit arms force the air flow to the cylinders and exhaust gas flow to the outside of the engine housing as shown with arrows.

It is to be understood that the methods and apparatus, which have been described above and shown on the drawings are merely illustrative applications of the principles of the invention. Numerous modifications may be made by those skilled in the are without departing from the true spirit and scope of the invention.

1. An internal combustion engine comprising of a rotating cylinder block with radially positioned cylinders open to the outside.

2. An internal combustion engine as described in claim (1) having valve units rotating and synchronized with the rotation of the cylinder block; the valve units consisting of a number of arms with ball at the end of each arm; each ball working as a valve that opens and closes hole in piston positioned inside cylinders; the cylinder block and valve units attached to shafts with reduction gears that transfer power to the power outlet shaft.

3. An internal combustion engine as described in claim (1) having piston units rotating and synchronized with the rotation of the cylinder block; the piston units consisting of a number of arms with piston at the end of each arm; each piston guided and restrained in movement by a piston guiding device, consisting of roller attached to a pin and a spring that pushes the roller to the piston; the cylinder block and the piston units attached to shafts with reduction gears that transfer power to the power outlet shaft.

4. An internal combustion engine as described in claim (1) having pistons with opening for inlet of air and outlet of combustion gas.

5. An internal combustion engine as described in claim (1) having electromagnetic rings at the bottom of cylinders that, when activated, hold pistons at the bottom of the cylinders making them inactive.

6. An internal combustion engine as described in claim (1) having a movement restricting magnetic ring at the entrance of each cylinder; the ring restricts piston movement by keeping the piston inside the cylinder and protecting it from movement outside cylinder caused by centrifugal force and pressure of combustion gases.

7. An internal combustion engine as described in claim (1) having valve units rotating and synchronized with the rotation of the cylinder block; the valve units consisting of a number of arms with ball at the end of each arm; each ball working as a valve that opens and closes hole in piston positioned inside cylinders; each ball attached to arm with a pin and a shell working as a bearing lubricated with oil supplied for such purpose through ducts shaft; the cylinder block and valve units attached to shafts with reduction gears that transfer power to the power outlet shaft.

8. An internal combustion engine as described in claim (1) having a valve guiding mechanism that synchronizes rotation of the cylinder block with rotation of valve units; such mechanism having cylindrical ends on arms of the guiding star that move inside slots in guiding disk providing synchronization between cylinder block shaft and the power intake shaft.

9. An internal combustion engine as described in claim (1) having a valve guiding mechanism that synchronizes rotation of the cylinder block with rotation of valve units; such mechanism having cylindrical ends on arms of the guiding star that move inside slots in guiding disk providing synchronization between cylinder block shaft and the power intake shaft.

10. An internal combustion engine as described in claim (1) having scavenging units; each scavenging units consisting of a number of arms with ball at the end of each arm; each ball only partially spherical and machined in the middle to allow combustion gases to escape from the inside of cylinder, while having sufficient contact to the piston to push it to the inside of each cylinder to squeeze out the gases; the scavenging units pushing the pistons to the inside the cylinders, not closing the opening during exhaust gas escape.
